(19) United States
(12) Patent Application Publication
(10) Pub. No.: US 2006/0202011 A1
(43) Pub. Date: Sep. 14, 2006

(54) Radio frequency aerial capable of remote identifying

(76) Inventors: Leeway Yen, Qionglin Shiang (TW); Chien-Hsing Fang, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/368,501

(22) Filed: Mar. 7, 2006

(30) Foreign Application Priority Data
Mar. 10, 2005 (TW) 094107324

(51) Int. Cl. G06F 17/00

(52) U.S. Cl. 235/375

(57) ABSTRACT

An radio frequency aerial is capable of remote identifying and applied in a wireless communication apparatus. The radio frequency aerial comprises an identification chip for receiving a radio frequency identification signal, therefore, not only transmitting for general radio frequency communication signal, but also for radio frequency identification signal. Thus, a product data stored in the identification chip can be directly transmitted to an exterior reading device via the radio frequency aerial and radio frequency identification signal without further setting up a chip aerial. In this way, not only is the radio frequency identification and communication ability of the exterior reading device and identification chip improved, but the aerial design of the identification chip and setting cost is simplified.

### FIELD OF THE INVENTION

The present invention is related to a radio frequency aerial, and more particularly to a radio frequency aerial capable of remote identifying and applied in a wireless communication apparatus. Not only is the radio frequency identification and communication ability of the exterior reading device and identification chip improved, but the aerial design of the identification chip and setting cost is simplified.

### BACKGROUND

Along with the frequent international trade, the division of labor in products gets more and more exquisite such that the circulation amount of products between countries becomes huge. Therefore, it becomes very important and complicated to control products. The traditional identifying and reading method of identifying the permutation and combination of strips of the bar code to represent product data is not enough for the product numbers now. Therefore, it is developed that a radio frequency label can be firmly established on an outer surface of products to replace prior art identification barcodes. By the feature of the radio frequency labels capable of storing a large number of digital codes, various product data can be thoroughly subdivided and assigned numbers to achieve an object of accurately controlling and fast reading products.

However, as shown in FIG. 1, the radio frequency identification label 11 used nowadays mainly uses a ring aerial 113 capable of receiving a radio frequency identification signal 195 to electrically connect to an identification chip 111 capable of storing a large number of product data 115 and attach to appropriate outer surface of a product 15, such as portable devices or wireless communication apparatuses, e.g. cell phones, by appropriately processing to make an exterior reading device 19 to connect to the radio frequency identification label 11 by a radio frequency identification signal 195 and obtain product data 115 previously stored in the radio frequency identification label 11.

Besides, in the wireless communication apparatus 155, it still comprises an external aerial 155 capable of proceeding radio frequency communication signals 197. The prior art structure cannot integrate the external aerial 155 and the chip aerial 113; therefore, the resource is wasted.

To this end, the radio frequency identification label 11 needs to be plastered or firmly established on an outer surface of the product 15 to be conveniently read data by the exterior reading device 119. Nevertheless, it thus affects the entire appearance of the product 15.

Further, the radio frequency identification label 11 is directly firmly established on the outer surface of the product 15. The product 15 is easy to be bumped and damaged by external objects during conveying or removed and stolen by thinking people in stores such that many abuses are occurred.

Besides, general radio frequency identification labels 11 all need to depend on sensing energy of the radio frequency identification signals 195 of the external reading device 19 to make the identification chip 111 operate, and thus the functions and working efficiency of the radio frequency identification labels 11 is limited. There is another kind of semi-active or active radio frequency identification label 11 using an extra battery to provide a working power for the radio frequency identification labels 11 to improve the function and working efficiency thereof; however, after the power of the battery exhausted, the radio frequency identification labels 11 loses a peripheral environment status of the sensed product 15 or an ability of actively providing product data 115 to the external device 19. A blind spot on the management of the product 15 is occurred, and furthermore the management and operation of the product 15 is affected.

Further, considering about manufacturing cost, general radio frequency identification labels 11 only use simple ring aerial 113 as a chip aerial thereof, and thus causing the radio frequency identification signals 195 badly sent when the products 15 stacked or blocked by electromagnetic separation occurs. In opposite, the external reading device 19 cannot smoothly obtain product data 115 such that a loophole occurs on the material management, and furthermore the circulation of entire products 15 is sluggish.

### SUMMARY OF THE INVENTION

To this end, how to design a radio frequency aerial against above mentioned shortcomings of the prior art technology, and more particularly a radio frequency aerial capable of remote identifying and used in a wireless communication apparatus which not only can improve the radio frequency identification and communication ability of the exterior reading device and identification chip, but simplify the aerial design of the identification chip and setting cost is an inventive point of the present invention. Therefore,

It is a primary object of the present invention to provide a radio frequency aerial capable of remote identifying. It mainly firmly establishes an identification chip on a radio frequency aerial of a wireless communication apparatus. In this way, a radio frequency identification ability of product data stored in the identification chip of an external reading device is strengthened.

It is a secondary object of the present invention to provide a radio frequency aerial capable of remote identifying which uses the feature of directly firmly establishing the identification chip on the radio frequency aerial to avoid product appearance from damaging. Not only is the beauty of the whole increased, but an object of raising buying desires of customers is achieved.

It is another object of the present invention to provide a radio frequency aerial capable of remote identifying which directly uses the power of the wireless communication apparatus itself to supply the identification chip so as to naturally become an active or semi-active structure. In this way, not only does the function and efficiency of the radio frequency aerial increase, but the working power of the active and semi-active identification chip is supplied, not limiting to using passive identification chips.

It is another object of the present invention to provide a radio frequency aerial capable of remote identifying which uses the feature of directly firmly establishing the identification chip on the radio frequency aerial and sharing the radio frequency aerial to save the arrangement cost and manufacturing steps of the prior art chip aerial.

To achieve the above mentioned objects, a preferred embodiment of the present invention provides a radio frequency aerial capable of remote identifying mainly comprising at least one transmission conductor electrically connected to a ground conductor and at least one identification chip such that the radio frequency aerial can transmit a radio frequency communication signal and a radio frequency identification signal, and the identification chip can connect to an exterior reading device via the radio frequency aerial and the radio frequency identification signal.

### BRIEF DESCRIPTION OF DRAWINGS

FIG. 1 is a structural diagram of a prior art radio frequency identification label.

FIG. 2 is a structural diagram of a preferred embodiment of a radio frequency aerial of the present invention.

FIG. 3 is an application diagram of applying in a wireless communication apparatus according to an embodiment of the present invention as shown in FIG. 2.

FIG. 4 is a structural diagram of another embodiment of a radio frequency aerial of the present invention.

FIG. 5 is a structural diagram of another embodiment of a radio frequency aerial of the present invention.

FIG. 6 is a structural diagram of another embodiment of a radio frequency aerial of the present invention.

### DETAILED DESCRIPTION

The structural features and the effects to be achieved may further be understood and appreciated by reference to the presently preferred embodiments together with the detailed description.

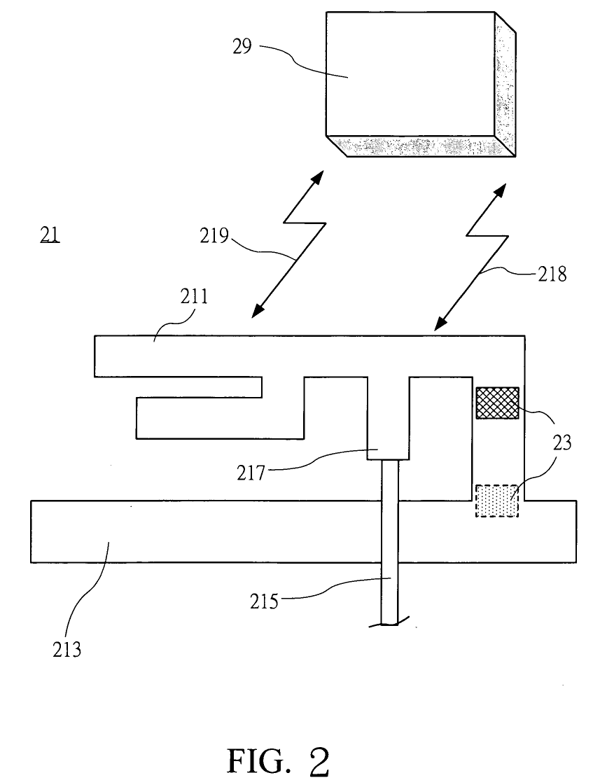

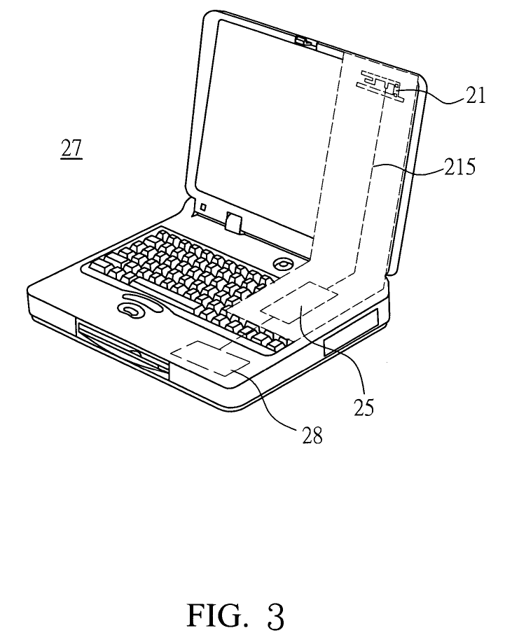

First, referring to FIGS. 2 to 3, respectively show a structural diagram and a use diagram of a preferred embodiment of the present invention. As shown, the radio frequency aerial with a remote identifying function and used in a wireless communication apparatus mainly firmly establishes at least one identification chip 23 on a radio frequency aerial 21, wherein the radio frequency aerial 21 is formed by mutually electrically connecting at least one communication conductor 211 and a ground conductor 213, such as radio frequency aerials 21 in general wireless communication apparatuses 27. The communication conductor 213 further has a communication point 217 and can be electrically connected to a radio frequency unit 25 of a wireless communication apparatus 27 via a communication line 215, such as radio frequency conductor, e.g. coaxial cable. In this way, the radio frequency unit 25 can receive or emit at least one radio frequency signal, such as a radio frequency communication signal 218 or a radio frequency identification signal 219, via the communication line 215 and radio frequency aerial 21.

The radio frequency aerial 21 of the present invention can be applied in portable devices or wireless communication apparatuses 28, such as a cell phone, notebook, personal digital assistant (PDA), global positioning system device (GPS), MP3 player, MP4 player, video/audio player, sound recording pen, or radio frequency signal reader.

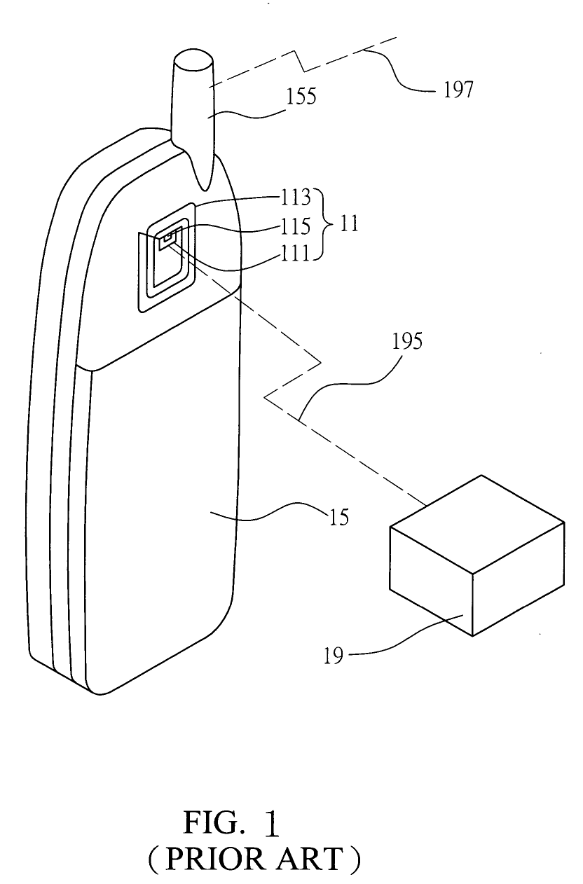

Of course, the radio frequency aerial 21 of the present invention can be selected as a form of the external aerial (155) of the wireless communication apparatus (15) as shown in FIG. 1 or a form of the build-in hidden aerial 21 of the wireless communication apparatus 27 as shown in FIG. 3.

Further, by the conductive feature of the radio frequency signals 218, 219, the present invention can set the identification chip 23 on the transmission conductor 211 or at a position of electrically connecting the ground conductor 213 and the transmission conductor 211 and electrically connect to the radio frequency aerial 21 such that the identification chip 23 can directly receive or emit a radio frequency signal 219 via the radio frequency aerial 21 and connect to an external reading device 29. Although the identification chip 23 exists as a load in opposite to the radio frequency signal 218 of the radio frequency aerial 21, the identification chip 23 consumes too little of the radio frequency signal 218 to affect the receiving or emitting the radio frequency signal 218 of the radio frequency aerial 21. Of course, the radio frequency communication quality of the radio frequency aerial 21 is not affected.

Further, the transmission conductor 211 of the radio frequency aerial 21 is generally designed to operate in coordination to the frequency range of the radio frequency communication signal 218 received by the wireless communication apparatus 27. Nowadays, the frequency range applied in the wireless communication apparatus 27 comprises radio frequency identification frequency range received or emitted by the identification chip 23. Even the radio frequency aerial 21 is not reserved for the use of the range of the radio frequency identification frequency 219 of the identification chip 23 such that the most receiving efficiency cannot be proceeded in the range of the radio frequency identification frequency 219 of the identification chip 23, since the identification chip 23 is a passive structure without a build-in power, by the energy of the radio frequency identification signal 219 of the external reading device 29, the working power needed by operating the passive identification chip 23 can also be supplied. Therefore, the identification chip 23 can still connect to the external reading device 29 by the transmission conductor 211 of the radio frequency aerial 21.

Further, since the identification chip 23 of the present invention can be set up and applied in the radio frequency aerial 21 of the wireless communication apparatus 27, electrically connected to the power supply 28 of the wireless communication apparatus 27 via the radio frequency aerial 21, communication line 215, or radio frequency unit 25 and directly uses the working power supplied by the power supply 28. In this way, not only does the identification chip 23 become a semi-active or an active radio frequency identification label to improve the working performance, but also the abuse of losing functions of the prior art structure since exhausting the working power can be avoided. Of course, the entire appearance of the wireless communication apparatus can be therefore maintained.

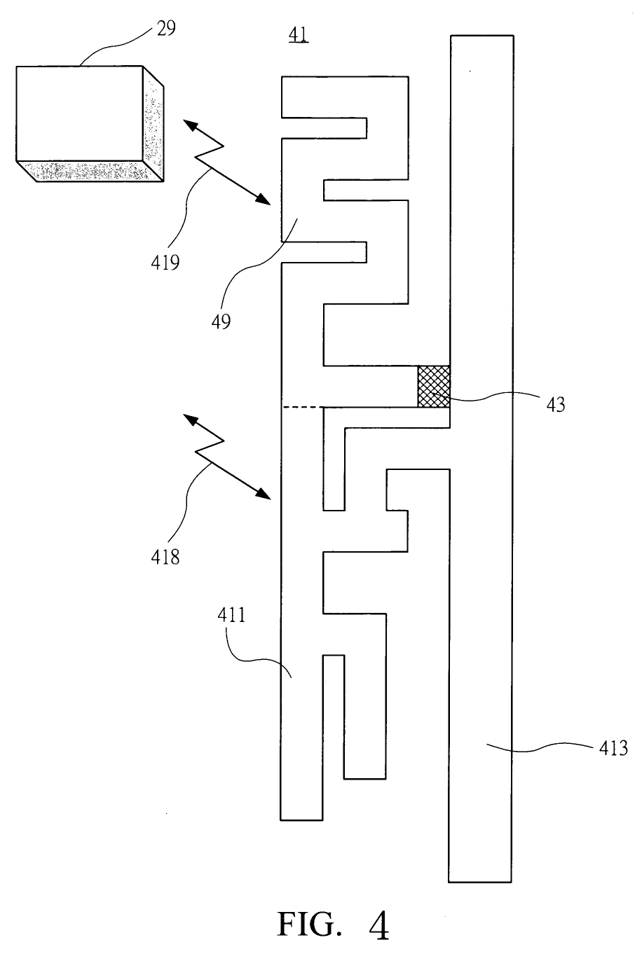

Moreover, please refer to FIG. 4, a structural diagram of another embodiment of the present invention. As shown, the radio frequency aerial 41 of the present invention can also connect to a secondary transmission conductor 49. An identification chip 43 is connected between such secondary transmission conductor 49 and a ground conductor 413. The secondary transmission conductor 49 can be directly designed as a structure suitable for the identification chip 43 to receive or emit the radio frequency signal 419. In this way, not only can the identification chip 43 connect to an external reading device 29 by the radio frequency identification signal 419 via the secondary transmission conductor 49, but also the main transmission conductor 411 can simply receive the radio frequency communication signal 418 needed by the wireless communication apparatus (27). The misgiving of affecting the ability of the transmission conductor (211) to emit or receive the communication signals will not be occurred.

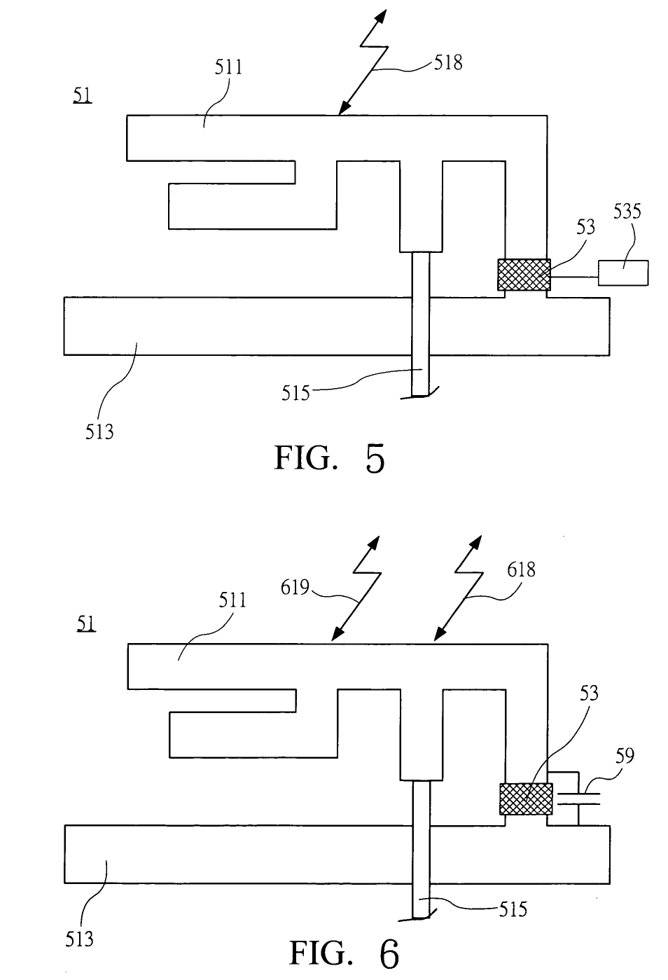

Continuously, please refer to FIG. 5, a structural diagram of another embodiment of present invention. As shown, the transmission conductor 511 comprised by the radio frequency aerial 51 of the present invention can electrically connect to a ground conductor 513 via an identification chip 53. In this way, when the transmission conductor 511 receives the radio frequency communication signal 518, some radio frequency signal 518 is transmitted to the identification chip 53 in addition to transmitting to the radio frequency unit (25) via the transmission line 515 such that the identification chip 53 can connect to an exterior reading device (29) with the radio frequency communication signal 518.

Further, the identification chip 53 can also connect to an optional power supply 535 to be used for the identification chip 53 when the wireless communication apparatus (27) is not started yet or the power supply (28) has no power.

Finally, referring to FIG. 6, shows a structural diagram of another embodiment of the present invention. As shown, the radio frequency aerial 51 of the present invention has a bypass capacitor 59. By the feature of the bypass capacitor 59 having low impedance to high frequency signals and high impedance to low frequency signals 619 such that a good ground effect can be obtained with such bypass capacitor 59 when the radio frequency communication signal 618 which is a high frequency signal flows on the communication conductor 511. Besides, the direct current power and low frequency signal 619 needed by the identification chip 53 can be supplied. Therefore, the direct current power can totally be used by the identification chip 53.

Of course, when the identification chip is an active identification chip, it can transmit the radio frequency identification signal 619 to connect to the products with radio frequency identification labels or identification chips in addition to sensing the peripheral environment state by itself anytime and actively connecting to a radio frequency identification signal 619 of an external reading device. In this way, the wireless communication apparatus (27) can also become a radio frequency identification reader to identify and read other product data to broaden the application scope of the wireless communication apparatus.

To sum up, it is appreciated that the present invention is related to a radio frequency aerial and more particularly to a radio frequency aerial capable of remote identifying and used in a wireless communication apparatus. Not only is the radio frequency identification and communication ability of the exterior reading device and identification chip improved, but the aerial design of the identification chip and setting cost is simplified.

The foregoing description is merely one embodiment of present invention and not considered as restrictive. All equivalent variations and modifications in process, method, feature, and spirit in accordance with the appended claims may be made without in any way from the scope of the invention.

1. A radio frequency aerial capable of remote identifying comprising:
at least one transmission conductor electrically connected to a ground conductor and at least one identification chip for transmitting a radio frequency communication signal and a radio frequency identification signal, said identification chip communicated with an exterior reading device by said radio frequency aerial and said radio frequency identification signal.

2. The radio frequency aerial according to claim 1, wherein said identification chip can be selectively provided on one of said transmission conductor and said ground conductor.

3. The radio frequency aerial according to claim 1, wherein said transmission conductor further electrically connects to a radio frequency unit and a power supply of a wireless communication apparatus via a transmission line for directly being operation power supplied by said power supply.

4. The radio frequency aerial according to claim 3, wherein said transmission line is a coaxial cable.

5. The radio frequency aerial according to claim 1, wherein said transmission conductor further connects to a secondary transmission conductor, said identification chip provided on said secondary transmission conductor.

6. The radio frequency aerial according to claim 5, wherein said transmission conductor transmits said radio frequency communication signal, and said secondary transmission conductor transmits said radio frequency identification signal.

7. The wireless communication apparatus according to claim 1, wherein said radio frequency aerial is selectively as one of a build-in hidden aerial and an external aerial of a wireless communication apparatus.

8. The radio frequency aerial according to claim 1, wherein said transmission conductor and ground conductor further electrically connects to a bypass capacitor.

9. The radio frequency aerial according to claim 1, wherein said identification chip is provided between said communication conductor and said ground conductor, and electrically connected to said communication conductor and said ground conductor, respectively.

10. The radio frequency aerial according to claim 1, wherein said identification chip can further electrically connect to an optional power supply.

11. The radio frequency aerial according to claim 1, wherein said radio frequency aerial is applied in a wireless communication apparatus, and said wireless communication apparatus is selectively as one of a cell phone, notebook, personal digital assistance, global positioning system device, MP3 player, MP4 player, video/audio player, sound recording pen, and radio frequency signal reader.
